(19) United States
(12) Patent Application Publication
(10) Pub. No.: US 2007/0225490 A1
(43) Pub. Date: Sep. 27, 2007

(54) Cationic Oligomer of a Saccharide for Resolving Enantiomers and Asymmetric Synthesis

(75) Inventors: Chi Bun Ching, Singapore (SG); David James Young, Queensland (AU); I Wayan Muderawan, Singapore (SG); Teng Teng Ong, Singapore (SG); Siu Choon Ng, Singapore (SG)

Correspondence Address: FISH & RICHARDSON, PC, P.O. BOX 1022, MINNEAPOLIS, MN, 55440-1022, US

(73) Assignee: SELEX SENSORS AND AIRBORNE SYSTEMS LIMITED, ESSEX (GB)

(21) Appl. No.: 10/582,048

(22) PCT Filed: Dec. 15, 2004
(86) PCT No.: PCT/SG04/00413

§ 371 Date: Mar. 6, 2007

Related U.S. Application Data
(60) Provisional application No. 60/529,112, filed on Dec. 15, 2003.

(51) Int. Cl. C08B 37/16

(52) U.S. Cl. 536/123.1

(57) ABSTRACT

A cationic oligomer of a saccharide, wherein the saccharide is functionalized by a cationic group, for example an ammonium, phosphonium, imidazolium, or pyridinium group. In a preferred embodiment, the cationic oligomer of a saccharide is a cationic cyclodextrin. There is also provided a use of the cationic oligomer of a saccharide as a chiral agent for resolving enantiomers by a chromatographic method or an asymmetric synthesis.

### CROSS REFERENCE TO RELATED APPLICATIONS

This application claims the benefit of U.S. Provisional Application No. 60/529,112, filed Dec. 15, 2003, which is incorporated herein by reference.

### FIELD OF THE INVENTION

The present invention relates to a cationic oligomer of a saccharide for resolving enantiomers. In particular, the invention relates to a cationic cyclodextrin for resolving enantiomers.

### BACKGROUND OF THE INVENTION

The resolution of racemic compounds has attracted great interest in analytical chemistry, especially in pharmaceutical analysis. Many isomeric pharmaceutical drugs frequently exhibit some stereoselectivity for pharmacological activity. Therefore, the separation of enantiomeric mixtures is one of the most important issues in pharmaceutical development. Furthermore, rapid, sensitive and selective analytical methods are required to control the chiral purity of the products.

Natural cyclodextrins (CD) and their derivatives are extensively used as chiral agents in separation and purification processes such as liquid chromatography (LC), high performance liquid chromatography (HPLC), capillary electrophoresis (CE) and super- and sub-critical fluid chromatography (SFC) due to their unique property to form inclusion complexes with other smaller hydrophobic molecules [1-4].

The use of an ionic cyclodextrin as a chiral agent in chromatography has shown great potential as an efficient chiral agent, offering enhanced discrimination for many chiral drugs. Additionally, ionic CDs have been shown to be effective in controlling enantiomer migration order in chromatography, however, the degree of substitution of an ionic CD has a critical effect on the resolution of the optical isomers [5-8].

Capillary electrophoresis (CE) has become a powerful tool for enantiomeric separations during the last decade. Concerning enantiomeric separation by CE, a simple theoretical model using cyclodextrin as a chiral agent was first proposed by S. A. C. Wren and R. C. Rowe [9]. Native CDs and derivatives have been widely accepted as chiral agents due to their characteristics of high water solubility, weak UV absorption and excellent chiral discrimination toward various aromatic enantiomers [10]. However, all enantiomers are not always separated with native CDs or their derivatives because they are electrically neutral. One limitation of neutral CDs as chiral agents is that neutral racemates cannot be resolved unless a different discrimination mechanism such as ionic micellar solubilization is added [11].

The use of an ionic CD offers new possibilities to separate neutral racemates because an ionic CD can move in the opposite direction to an analyte and shows capability as an ion-pairing agent and thus enhancing the resolution of enantiomers [12]. Ionic CDs have several advantages for the enantiomer separations over natural CDs. Strong electrostatic interactions between an ionic CD and an oppositely charged analyte are effective for the formation of an inclusion complex. Also, the large difference in electrophoretic mobility between a free analyte and an inclusion complex enhance enantiomeric resolution [13].

Ionic cyclodextrins that are commonly used in chromatography can be classified as anionic, cationic, and amphoteric or zwitterionic. A commercial amphoteric β-CD (AM-β-CD) such as carboxymethyl hydroxypropyltrimethylammonium-β-CD has both cationic and anionic substituents [14]. When the degree of substitution is equal between cationic and anionic substituents, the CDs have no net charge in a buffer solution unless the pH is extremely low or high. It is not known whether these CDs are charged or not in buffer solution.

At present, more anionic than cationic cyclodextrin derivatives are used in chiral chromatography separations. Although cationic derivatives have been synthesized previously, they were not often used in separation. For example, an amino-functionalized cyclodextrin was used as a model for studying enzymatic biological processes involving a positively charged group in the vicinity of the active site [15] and mono-6-(alkylamino)-β-cyclodextrins also have been used for studying the mechanism of cooperative binding of organic guests by aggregated cationic alkyl cyclodextrin [16].

The earliest cationic cyclodextrin derivatives to be used for CE applications were mono-(6-β-aminoethylamino-6-deoxy)-β-cyclodextrin [17], 6^{A}-methylamino and 6^{A,D}-dimethylamino-β-cyclodextrins [18], 6-amino-β-cyclodextrin [19] and 6-ethylenediamine-β-cyclodextrin [20]. A commercial quaternary ammonium hydroxypropyl-β-cyclodextrin (QA-β-CD), a randomly functionalized CD with a degree of substitution of three to five groups, has been successfully used as chiral selector for enantiomer separations of various acidic racemates by CE [14]. As compared to neutral CD derivatives, QA-β-CD is effective for the enantiomer separations at low concentration below 5 mM due to the strong electrostatic interaction between cationic CD and anionic analytes. However, the QA-β-CD is not useful for the enantiomer separation of hydrophobic compounds such as arylpropionic acid and warfarin because of too strong interactions with the CD due to the degree of substitution. The substitution distribution significantly influences the enantioselectivity and peak shapes. Therefore, pure single charged CD derivatives (DS=1) as chiral agents should provide a high plate number and good reproducibility for enantiomer separations by CE.

### SUMMARY OF THE INVENTION

According to one aspect of the present invention, there is provided a cationic oligomer of a saccharide of the general formula (I) 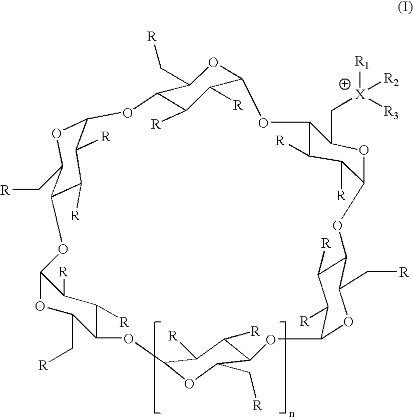
wherein n=0 to 8;
X is nitrogen or phosphorous;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy(C₁-C₂₀)alkyl, aryl, or aryl(C₁-C₂₀)alkyl; and
R₁, R₂ and R₃ are each independently selected from the group consisting of hydrogen, linear or branched (C₁-C₂₀)alkyl, linear or branched (C₁-C₂₀)alkenyl, linear or branched (C₁-C₂₀) alkynyl, and cycloalkyl; or
R₁ is absent, and R₂ and R₃ are taken together with X to form a ring having the following structure: 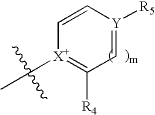
   wherein m=0 or 1;
Y is carbon or nitrogen;
R₄ is hydrogen, linear or branched (C₁-C₂₀)alkyl, linear or branched (C₁-C₂₀)alkenyl, linear or branched (C₁-C₂₀)alkynyl, or cycloalkyl; and
R₅ is hydrogen, 2-(2-ethoxyethoxy)ethyl, linear or branched (C₁-C₂₀)alkyl, linear or branched (C₁-C₂₀)alkenyl, linear or branched (C₁-C₂₀)alkynyl, cycloalkyl, or NR₆R₇, wherein R₆ and R₇ are each independently selected from the group consisting of hydrogen, linear or branched (C₁-C₂₀)alkyl, linear or branched (C₁-C₂₀)alkenyl, linear or branched (C₁-C₂₀)alkynyl, and cycloalkyl.

According to another aspect of the present invention, there is provided a cationic oligomer of a saccharide of the general formula (I) 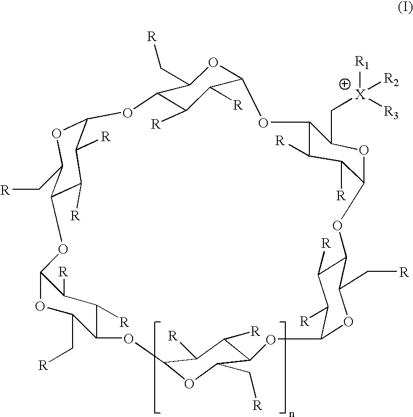
wherein n=0 to 8;
X is nitrogen or phosphorous;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy(C₁-C₂₀)alkyl, aryl, or aryl(C₁-C₂₀)alkyl; and
R₁, R₂ and R₃ are each independently selected from the group consisting of hydrogen, linear or branched(C₁-C₂₀)alkyl, linear or branched(C₁-C₂₀)alkenyl, linear or branched(C₁-C₂₀)alkynyl, and cycloalkyl.

According to yet another aspect of the present invention, there is provided a cationic oligomer of a saccharide of the general formula (II) 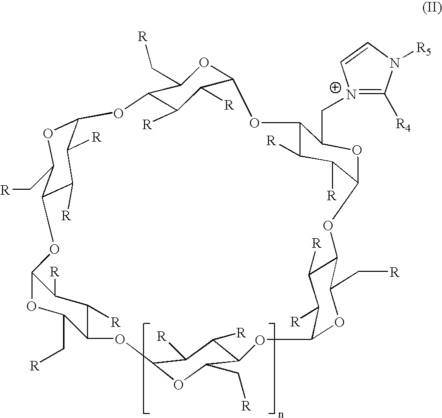
wherein n=0 to 8;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy (C₁-C₂₀) alkyl, aryl, or aryl (C₁-C₂₀) alkyl; and
R₄ is hydrogen, linear or branched (C₁-C₂₀)alkyl, linear or branched (C₁-C₂₀)alkenyl, linear or branched (C₁-C₂₀)alkynyl, or cycloalkyl; and
R₅ is hydrogen, 2-(2-ethoxyethoxy)ethyl, linear or branched (C₁-C₂₀)alkyl, linear or branched (C₁-C₂₀)alkenyl, linear or branched (C₁-C₂₀)alkynyl, or cycloalkyl.

According to still another aspect of the present invention, there is provided a cationic oligomer of a saccharide of the general formula (III) 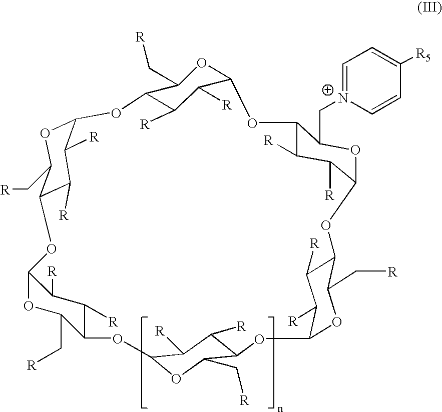
wherein n=0 to 8;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy(C₁-C₂₀)alkyl, aryl, or aryl(C₁-C₂₀)alkyl; and
R₅ is hydrogen, linear or branched (C₁-C₂₀)alkyl, linear or branched (C₁-C₂₀)alkenyl, linear or branched (C₁-C₂₀)alkynyl, cycloalkyl, or NR₆R₇, wherein R₆ and R₇ are each independently selected from the group consisting of hydrogen, linear or branched (C₁-C₂₀)alkyl, linear or branched (C₁-C₂₀)alkenyl, linear or branched (C₁-C₂₀)alkynyl, and cycloalkyl.

According to a further aspect of the present invention, there is provided a method of preparing a cationic oligomer of a saccharide, as defined herein, comprising reacting an amine, a phosphine, an imidazole, or a pyridine with a oligomer of a saccharide having a leaving group.

According to another aspect of the present invention, there is provided a use of a cationic oligomer of a saccharide, as defined herein, as chiral agent for resolving enantiomers by a chromatographic method.

According to another aspect of the present invention, there is provided a use of a cationic oligomer of a saccharide, as defined herein, as a chiral agent for an asymmetric synthesis.

### BRIEF DESCRIPTION OF THE DRAWINGS

In order that the present invention may be more clearly understood, preferred embodiments thereof will now be described in detail by way of example, with reference to the accompanying drawings, in which:

FIGS. 1, 2 and 3 are chromatograms depicting the CE enantioseparation of racemates using methylimidazolium-β-cyclodextrin as chiral agent;

FIGS. 4, 5 and 6 are chromatograms depicting the CE enantioseparation of racemates using allylammonium-β-cyclodextrin as chiral agent;

FIGS. 7, 8, and 9 are chromatograms depicting the CE enantioseparation of racemates using propylammonium-β-cyclodextrin as chiral agent;

FIG. 10, 11 and 12 are chromatograms depicting the CE enantioseparation of racemates using pentylammonium-β-cyclodextrin as chiral agent; and

FIG. 13 depicts asymmetric reactions using a cationic oligomer of a saccharide, for example a cationic cyclodextrin, as a chiral agent.

### DETAILED DESCRIPTION OF THE PREFERRED EMBODIMENTS

The present invention makes use of a cationic oligomer of a saccharide for resolving enantiomers. The cationic oligomer of a saccharide may be straight-chained or cyclic, and functionalized by a cationic group such as an ammonium, phosphonium, imidazolium, or pyridinium group. Preferably, the cationic oligomer of a saccharide is singly charged.

Examples of a saccharide include, without limitation, glucose, fructose, mannose, galactose, ribose, arabinose, xylose, lyxose, erythrose and threose. The preferred saccharide is glucose. The glucose moiety may be functionalized at any one of the 2-, 3-, or 6-positions by the cationic group.

Additionally, any hydroxyl group of the cationic oligomer of a saccharide may be modified. Examples of suitable modifications are linear or branched chain (C₁-C₂₀) alkyl, hydroxy(C₁-C₂₀)alkyl, carboxy(C₁-C₂₀)alkyl, aryl, aryl(C₁-C₂₀)alkyl, ester, carbamate, carbonate, phosphinate, phosphonate, phosphate, sulfinate, sulfite, sulfonate, and sulphate.

Preferably, the cationic oligomer of a saccharide is a cyclic cationic oligomer of a saccharide, especially a cationic cyclodextrin. The cyclic cationic oligomer of a saccharide preferably comprises 5 to 13 glucose moieties, and most preferably comprises 6 to 8 glucose moieties. However, a straight-chained cationic oligomer such as a cationic cellulose, amylose or pullulan is also contemplated. They may be used in the form of their ester, for example cellulose acetate.

The term “alkyl” refers to the radical of saturated aliphatic groups, including straight chain alkyl groups, branched-chain alkyl groups, cycloalkyl (alicyclic) groups, alkyl substituted cycloalkyl groups, and cycloalkyl substituted alkyl groups. Typical alkyl groups include, but are not limited to, methyl, ethyl, propyl, isopropyl, butyl, isobutyl, t-butyl, pentyl, isopentyl, hexyl, etc. The alkyl groups can be (C₁-C₂₀) alkyl. A “substituted alkyl” has substituents replacing a hydrogen on one or more carbons of the hydrocarbon backbone. Such substituents can include, for example, halogen, hydroxyl, carbonyl (such as carboxyl, ketones (including alkylcarbonyl and arylcarbonyl groups), and esters (including alkyloxycarbonyl and aryloxycarbonyl groups)), thiocarbonyl, acyloxy, alkoxyl, phosphoryl, phosphonate, phosphinate, amino, acylamino, amido, amidine, imino, cyano, nitro, azido, sulfhydryl, alkylthio, sulfate, sulfonate, sulfamoyl, sulfonamido, heterocyclyl, aralkyl, or an aromatic or heteroaromatic moiety. The moieties substituted on the hydrocarbon chain can themselves be substituted, if appropriate. For instance, the substituents of a substituted alkyl may include substituted and unsubstituted forms of aminos, azidos, iminos, amidos, phosphoryls (including phosphonates and phosphinates), sulfonyls (including sulfates, sulfonamidos, sulfamoyls and sulfonates), and silyl groups, as well as ethers, alkylthios, carbonyls (including ketones, aldehydes, carboxylates, and esters), —CF₃, —CN and the like. Exemplary substituted alkyls are described below. Cycloalkyls can be further substituted with alkyls, alkenyls, alkoxys, alkylthios, aminoalkyls, carbonyl-substituted alkyls, —CF₃, —CN, and the like.

The terms “alkenyl” and “alkynyl” refer to unsaturated aliphatic groups analogous in length and possible substitution to the alkyls described above, but that contain at least one double or triple bond respectively. An “alkenyl” is an unsaturated branched, straight chain, or cyclic hydrocarbon radical with at least one carbon-carbon double bond. The radical can be in either the cis or trans conformation about the double bond(s). Typical alkenyl groups include, but are not limited to, ethenyl, propenyl, isopropenyl, butenyl, isobutenyl, tert-butenyl, pentenyl, hexenyl, etc. An “alkynyl” is an unsaturated branched, straight chain, or oyclic hydrocarbon radical with at least one carbon-carbon triple bond. Typical alkynyl groups include, but are not limited to, ethynyl, propynyl, butynyl, isobutynyl, pentynyl, hexynyl, etc.

In a preferred embodiment, the cationic oligomer of a saccharide may be of the general formula (I) 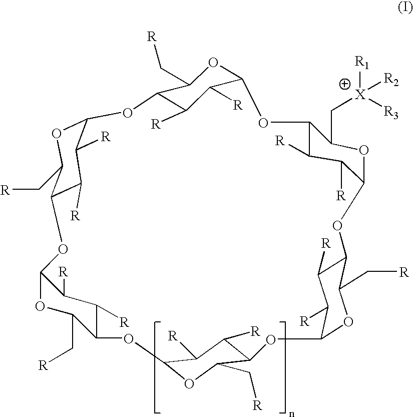
wherein X is preferably nitrogen or phosphorous, and n is preferably 0 to 8, and more preferably 1 to 3.

The R group may be a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy(C₁-C₂₀)alkyl, aryl, or aryl(C₁-C₂₀) alkyl.

The R₁, R₂ and R₃ groups are each independently selected from the group consisting of hydrogen, linear or branched (C₁-C₂₀) alkyl, linear or branched (C₁-C₂₀) alkenyl, linear or branched(C₁-C₂₀)alkynyl, or cycloalkyl. Alternatively, R₁ is absent, and R₂ and R₃ are taken together with X to form a ring having the following structure: 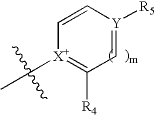
wherein Y is preferably carbon or nitrogen, and m is preferably 0 or 1.

The R₄ group may be selected from hydrogen, linear or branched (C₁-C₂₀)alkyl, linear or branched (C₁-C₂₀)alkenyl, linear or branched (C₁-C₂₀)alkynyl, or cycloalkyl.

The R₅ group may be hydrogen, 2-(2-ethoxyethoxy) ethyl, linear or branched (C₁-C₂₀)alkyl, linear or branched (C₁-C₂₀)alkenyl, linear or branched (C₁-C₂₀)alkynyl, cycloalkyl, or NR₆R₇, wherein R₆ and R₇ are each independently selected from the group consisting of hydrogen, linear or branched (C₁-C₂₀)alkyl, linear or branched (C₁-C₂₀)alkenyl, linear or branched (C₁-C₂₀)alkynyl, and cycloalkyl.

The cationic cyclodextrin (I) may also be a salt thereof comprising a counterion. A preferred counterion may be selected from the group consisting of fluoride, chloride, bromide, iodide, nitrate, HCO₃⁻, CO₃^{2 -}, HSO₄⁻, BF₄⁻, BCl₄⁻, PF₆⁻, SbF₆₋, AsF₆⁻, AlCl₄⁻, R₉—CO₂⁻and R₉—SO₃³¹ , wherein R₉ is a hydrogen, linear or branched (C₁-C₂₀)alkyl, linear or branched (C₁-C₂₀)alkenyl, linear or branched (C₁-C₂₀)alkynyl, cycloalkyl, or aryl (C₁-C₂₀) alkyl.

In further preferred embodiments, the cationic cyclodextrin may be of the general formula (I), (II), and (III): 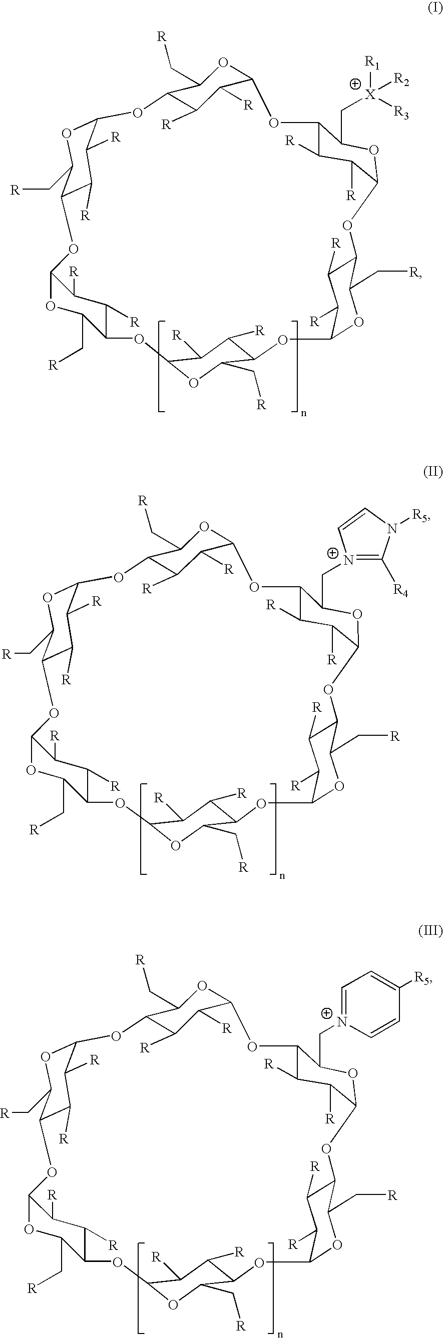
wherein n is preferably 0 to 8, and more preferably 1 to 3.
When n is any one of 1 to 3, the cationic cyclodextrin is referred to as an α-, β- and γ-cyclodexrin, respectively.
The cationic cyclodextrin (I) is mono-functionalized by an ammonium or a phosphonium group, the cationic cyclodextrin (II) is mono-functionalized by an imidazolium group, and the cationic cyclodextrin (III) is mono-functionalized by a pyridinium group. In each case, the cyclodextrin is mono-functionalized at the 6-position, however functionalization at the 2- and 3-position is also contemplated.

The R group may be a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy(C₁-C₂₀)alkyl, aryl, or aryl(C₁-C₂₀) alkyl.

The R₁, R₂ and R₃ groups are preferably each independently selected from the group consisting of hydrogen, linear or branched (C₁-C₂₀)alkyl, linear or branched (C₁-C₂₀) alkenyl, linear or branched (C₁-C₂₀)alkynyl, or cycloalkyl.

The R₄ group is preferably hydrogen, linear or branched (C₁-C₂₀)alkyl, linear or branched (C₁-C₂₀)alkenyl, linear or branched (C₁-C₂₀)alkynyl, or cycloalkyl, and more preferably a hydrogen or methyl group.

The R₅ group is preferably hydrogen, 2-(2-ethoxyethoxy)ethyl, linear or branched (C₁-C₂₀)alkyl, linear or branched (C₁-C₂₀)alkenyl, linear or branched (C₁-C₂₀)alkynyl, cycloalkyl or NR₆R₇, whereby R₆ and R₇ are each independently selected from the group consisting of hydrogen, linear or branched (C₁-C₂₀)alkyl, linear or branched (C₁-C₂₀)alkenyl, linear or branched (C₁-C₂₀)alkynyl, or cycloalkyl.

The cationic cyclodextrin (I), (II), or (III) may also be a salt thereof comprising a counterion. A preferred counterion is selected from the group consisting of fluoride, chloride, bromide, iodide, nitrate, HCO₃⁻, CO₃²⁻, HSO₄⁻, BF₄⁻, BCl₄⁻, PF₆⁻, SbF₆⁻, AsF₆⁻, AlCl₄⁻, R₉—CO₂⁻and R₉—SO₃⁻, wherein R₉ is a linear or branched (C₁-C₂₀)alkyl, linear or branched (C₁-C₂₀) alkenyl, linear or branched (C₁-C₂₀)alkynyl, cycloalkyl, or (C₁-C₂₀)alkyl aryl.

A method for preparing a cationic oligomer of a saccharide comprises the reaction of an amine, a phosphine, an imidazole, or a pyridine with a oligomer of a saccharide functionalized by a leaving group. Preferably, the amine, phosphine, imidazole, and pyridine are 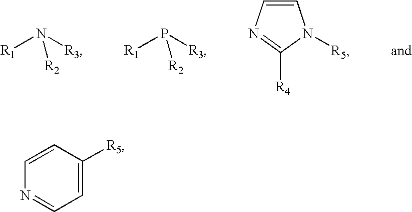
respectively wherein R₁, R₂, R₃, R₄, R₅ and R₆ are defined herein.

The cationic oligomer of a saccharide may be, for example, a cationic oligomer of a glucose, wherein a hydroxyl group of the glucose moiety of a cyclodextrin is converted to a leaving group at the 2-, 3-, or 6-position, preferably at the 6-position.

Examples of a leaving group include, without limitation, a mesylate, a tosylate, a triflate, a haloformate ester or a halide group, such as iodide, bromide, or chloride.

Examples of reagents that can be used to convert a hydroxyl group of the glucose moiety to a leaving group include, without limitation, SOCl₂, PBr₃, tosyl chloride, mesyl chloride, triflic anhydride, and an ester of chloroformic acid.

Preferably, only the hydroxyl groups at the 6-position of the glucose moieties are converted to leaving groups. Conversion of hydroxyl groups at the 2- and 3-positions, in addition to the 6-position, to leaving groups, is also, however, within the scope of the invention. Conversion of hydroxyl groups at the 2-, 3- or 6-positions may be partial or complete.

As primary hydroxyl groups react more readily than secondary hydroxyl groups, it is possible to ensure that only the primary hydroxyl groups are converted to leaving groups by selection of the appropriate molar ratios of reagent to hydroxyl groups. Preferably only some of the primary hydroxyl groups of the glucose moieties of the oligomer of a saccharide are converted to leaving groups, and more preferably, only one of the primary hydroxyl groups is converted to a leaving group.

In the case where conversion of a hydroxyl group at the 2- or 3-position is desired, it is preferred that only one of the 2- or 3-positions is converted to a leaving group. Preferably only some of the hydroxyl groups of the glucose moieties of the oligomer of a saccharide are converted to leaving groups, and more preferably, only one of the hydroxyl groups is converted to a leaving group.

Once functionalized cationically, any remaining hydroxyl groups at the 2-, 3- and 6-carbon atom positions of the glucose moieties of the cationic oligomer of a saccharide may be modified by a protecting group. These remaining hydroxyl groups may be partially or fully functionalized. The expression “fully-functionalized” as used herein indicates that all of the hydroxyl groups of the glucose moieties have been either protected with a protecting group or derivatized with a derivatizing agent. It is to be appreciated, however, that the functionalizing or derivatizing reaction may not go entirely to completion, so there may be one or more hydroxyl groups still present. Alternatively, the hydroxyl group of a oligomer of a saccharide may be modified before addition of a cationic group.

The remaining hydroxyl groups of the cationic oligomer of a saccharide may be functionalized to form, for example, an alkoxy, an aryloxy, an arylalkyloxy, an ester, a carbamate, a carbonate, a phosphinate, a-phosphonate, a phosphate, a sulfinate, a sulfite, a sulfonate or a sulphate.

If the hydroxyl group is to be converted to alkoxy, aryloxy or arylalkyloxy, it could be done, for example, by alkylating with a compound of formula (V):
R₁₀Y (V)
wherein R₁₀ is an alkyl, an aryl or an arylalkyl group, and Y is a leaving group, for example, a halide such as iodide, bromide or chloride, or a tosylate, a mesylate or a triflate.

If the hydroxyl group is to be converted to an ester or a carbonate, it could be done, for example, by acylating with a compound of formula (VI): 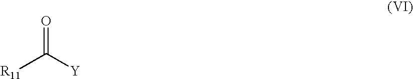
wherein R₁₁ is an alkyl, an aryl, an arylalkyl, an alkoxy, an aryloxy, or an arylalkyloxy group, and Y is as defined above; or by acylating them with a compound of formula (VII): 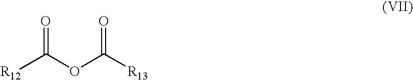
wherein R₁₂ and R₁₃ are independently an alkyl, an aryl, an arylalkyl, an alkoxy, an aryloxy, or an arylalkyloxy group.

If the hydroxyl group is to be converted to a carbamate, it could be done, for example, by reacting with a compound of formula (VIII):
R₁₄—N═C═O (VIII)
where R₁₄ is an alkyl, an aryl or an arylalkyl group.

If the hydroxyl group is to be converted to a phosphinate, a phosphonate, or a phosphate, it could be done, for example, by reacting with a compound of formula (IX): 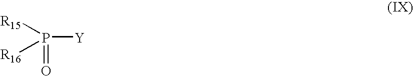
where R₁₅ and R₁₆ are, independently, hydrogen, an alkyl, an aryl, an arylalkyl, an alkoxy, an aryloxy, or an arylalkyloxy group, and Y is as defined above.

If the hydroxyl group is to be converted to a sulfinate or a sulfite, it could be done, for example, by reacting with a compound of formula (X): 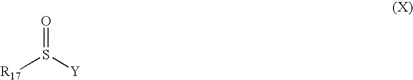
or conversion to a sulfonate or a sulfate group by reacting them with a compound of formula (XI): 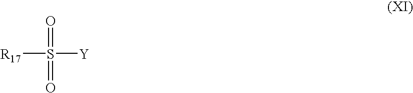
wherein R₁₇ is an alkyl, an aryl, an arylalkyl, an alkoxy, an aryloxy, or an arylalkyloxy group, and Y is as defined above.

Any of the hydroxyl groups that are to be functionalized are preferably functionalized using a large molar excess of functionalizing agent in order to promote full functionalization. Preferably, the excess is in the range of from about 10:1 to about 50:1, more preferably from about 20:1 to about 40:1.

In a particularly advantageous embodiment of the invention there is a method of preparing a cationic oligomer of a saccharide by an almost quantitative reaction of pre-synthesized regiodefined monotosylated cyclodextrin with an amine, a phosphine, an imidazole, or a pyridine. Mono-tosylcyclodextrins are important precursors for a variety of modified cyclodextrins because a nucleophile can attack the electrophilic carbon atom at the 6- and 2-positions to produce a corresponding functionalized cyclodextrin [21]. A nucleophilic displacement of the tosyl group by any one of an amine, a phosphine, an imidazole or a pyridine affords a cationic ammonium, phosphonium, imidazolium or pyridinium cyclodextrin, respectively.

Preferably, the amine, phosphine, imidazole, and pyridine are 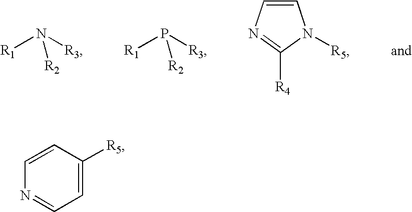
respectively, wherein R₁, R₂, R₃, R₄, R₅ and R₆ are defined herein.

In a further preferred embodiment, the invention makes use of a cationic oligomer of a saccharide, as defined herein, as chiral agent for resolving enantiomers by a chromatographic method. Preferably, the cationic oligomer of a saccharide is based on a cationic cyclodextrin derivative as described herein for use as the chiral agent.

The chromatographic method is preferably selected from the group consisting of gas chromatography (GC), liquid chromatography (LC), high performance liquid chromatography (HPLC), capillary electrophoresis (CE), and sub- or super-critical fluid chromatography (SFC).

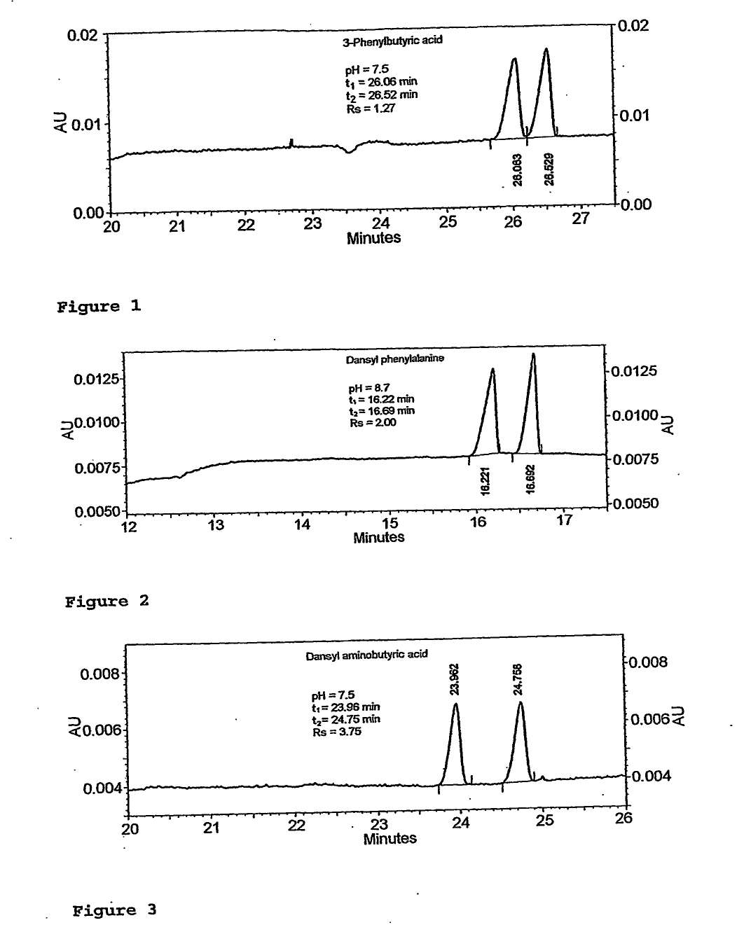

FIGS. 1-9 are capillary electrophoresis (CE) chromatograms showing the enantioseparation of the racemates of a number of compounds. The symbols t₁ and t₂ are the migration times of the enantiomers measured in minutes and R is the resolution for a pair of enantiomers.

Specifically, FIGS. 1, 2 and 3 are three chromatograms illustrating the enantioseparation of the racemates of each 3-phenylbutyric acid, dansyl phenylalanine and dansyl aminobutyric acid, respectively, using methylimidazolium-β-cyclodextrin as a chiral agent in a buffer having a pH between 7.5 and 8.7.

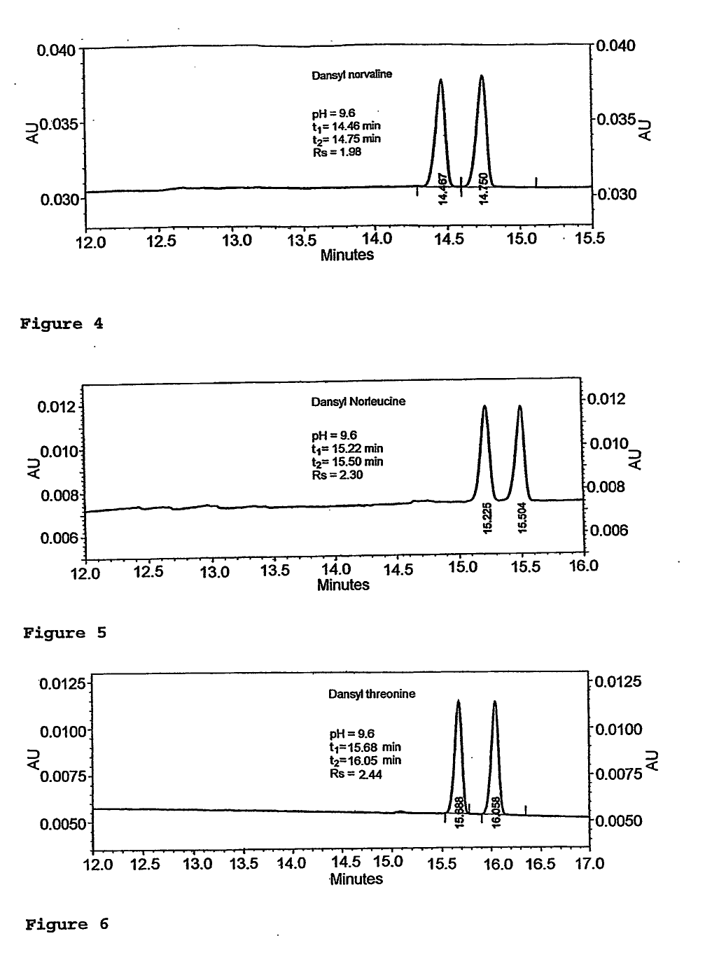

FIGS. 4, 5 and 6 are the three chromatograms illustrating the enantioseparation of the racemates of each dansyl norvaline, dansyl norleucine and dansyl threonine, respectively, using butylimidazolium-β-cyclodextrin as a chiral agent in a buffer having a pH of 9.6.

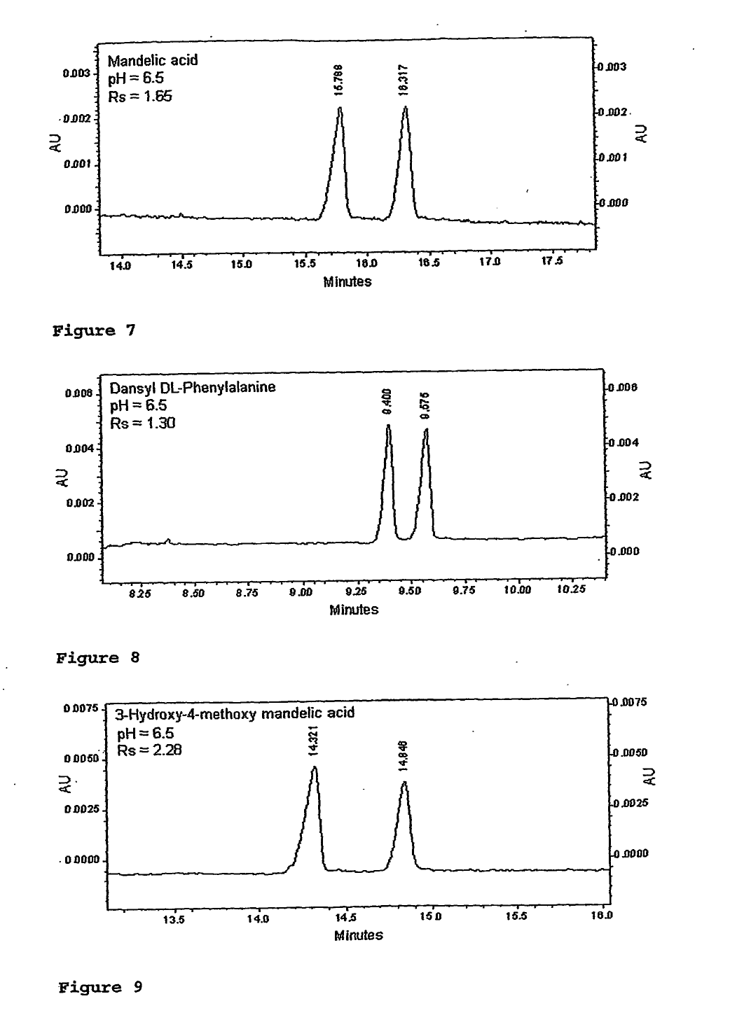

FIGS. 7, 8 and 9 are three chromatograms illustrating the enantioseparation of the racemates of each mandelic acid, dansyl DL-phenylalanine and 3-hydroxy-4-methoxy mandelic acid, respectively, using propylammonium-β-cyclodextrin as chiral selector in buffers having a pH of 6.5.

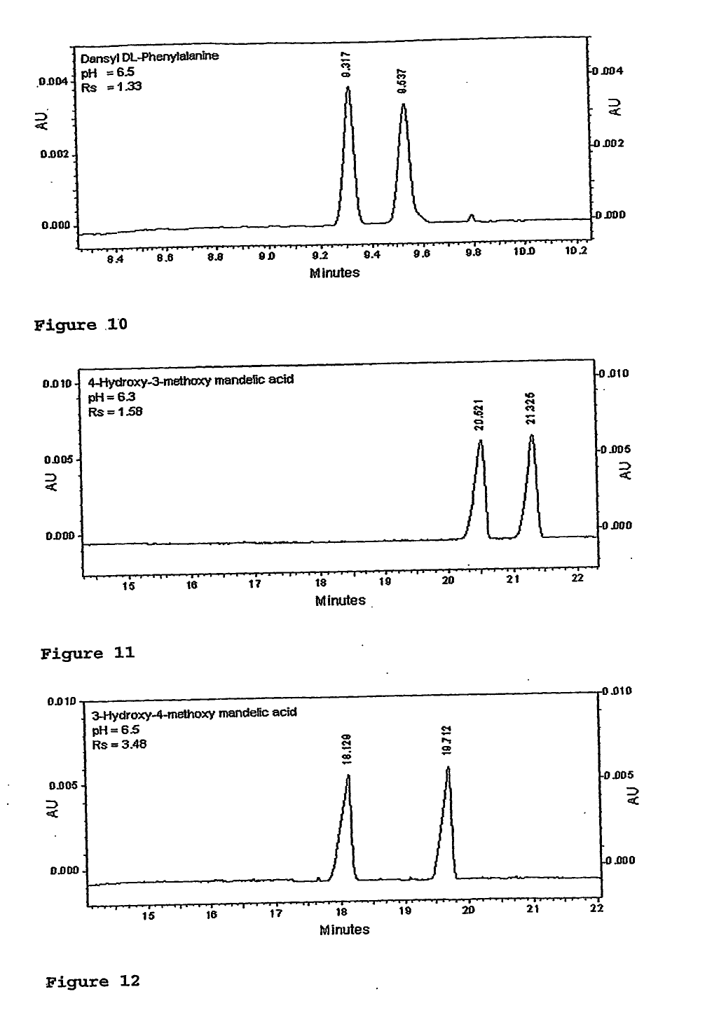

FIGS. 10, 11 and 12 are three chromatograms illustrating the enantioseparation of the racemates of each dansyl DL-phenylalanine, 4-hydroxy-3-methoxy mandelic acid and 3-hydroxy-4-methoxy mandelic acid, respectively, using pentylammonium-β-cyclodextrin as chiral selector in buffers having a pH of 6.5.

Further application of the cationic oligomer of a saccharide, such as the cationic cyclodextrin, is their use for asymmetric synthesis, for example, in reduction and pericyclic reactions, eg. ene reaction, Diel Alder reaction.

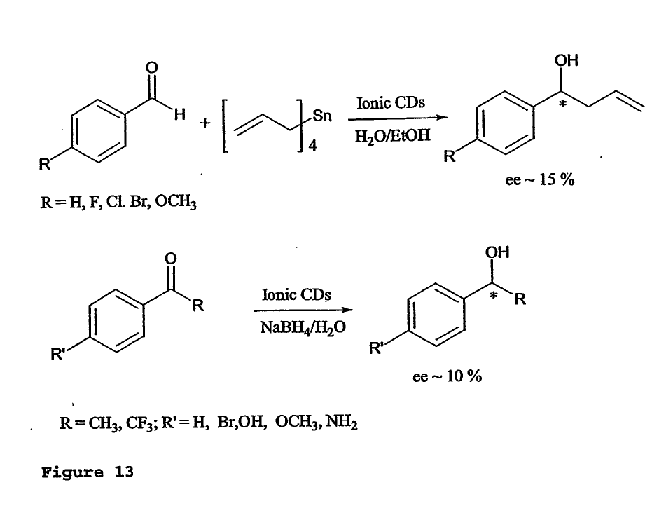

FIG. 13 illustrates the asymmetric reaction of aryl aldehydes and aryl ketones using a cationic oligomer of a saccharide such as cationic cyclodextrin. In the first reaction scheme, allylation of an aryl aldehyde occurs using tetraallyl tin and a cationic oligomer of a saccharide such as cationic cyclodextrin to produce a chiral secondary alcohol in 15% enantiomeric excess. In the second reaction scheme, reduction of an aryl ketone occurs using sodium borohydride and a cationic oligomer of a saccharide such as cationic cyclodextrin to produce a chiral secondary alcohol in 10% enantiomeric excess.

### EXAMPLES

The following examples are provided to illustrate the invention. It will be understood, however, that the specific details given in each example have been selected for the purpose of illustration and are not to be construed as limiting in scope of the invention.

β-Cyclodextrin monofunctionalized with a tosyl group at the 6-position was prepared using the previously reported procedure by B. Brady, N. Lynam, T. O'Sullivan, C. Ahern, and R. Darcy, [22], and at the 2-position was prepared using the previously reported procedure by T. Murakami, K. Harata, and S. Morimoto [23].

Alkylimidazolium-β-cyclodextrin tosylate was prepared by stirring mono-6-tosyl-β-cyclodextrin with alkylimidazole in DMF at 90° C. for 2 days in very good yields.

Allyl and alkylammonium-p-cyclodextrin tosylates were prepared by refluxing mono-6-tosyl-β-cyclodextrin or mono-2-tosyl-β-cyclodextrin with allylamine, propylamine, pentylamine in DMF at 90° C. for 5 hours or 6 days in very good yields.

The tosylate anion could be exchanged with other anions by ion-exchange using Amberlite resin.

### Example 1

### Synthesis of 6-deoxy-6-(methylimidazolium)-β-cyclodextrin tosylate

A mixture of 6-O-tosyl-β-cyclodextrin (12.892 g, 0.01 mol) and an excess of 1-methylimidazole (5.0 g, 0.061 mol) was stirred under nitrogen at 90° C. for 2 days. Excess 1-methylimidazole was then removed under vacuum to give light yellow paste. Acetone was-added to the light yellow paste and stirred for 30 minutes to allow a solid to form. The pale solid was filtered and washed with acetone followed by drying under high vacuum to afford a white solid (13.50 g, 98.5%); mp. 257° C. (dec.).

IR (KBr) ν: 3399, 2927, 1638, 1600, 1413, 1335, 1305, 1155, 1080, 1032, 943, 843, 754, 683, 577 cm⁻. MS (ESI, m/e, relative intensity %), 1199.60 (M⁺, 100), calcd. 1199.42; 171.30 (⁻OTs, 86), calcd. 171.17.

¹H NMR (500 MHz, DMSO-d₆) δ: 2.30 (s, 3H, CH_{3Ts}), 2.82 (t, 1H, J=6.01 Hz, H-2), 3.06 (t, 1H, J=6.05 Hz, H-4), 3.23 (t, 1H, J=9.25 Hz, H-5), 3.31-3.47 (m, 12H, H-2,4), 3.50-3.64 (m, 27H, H-3,5,6), 3.85 (s, 3H, CH₃ᵢₘ), 4.32 (t, 1H, J=9.24 Hz, OH-6), 4.50 (t, 1H, J=5.61 Hz, OH-6), 4.56 (t, 4H, J=5.61 Hz, OH-6), 4.84 (d, 6H, J=3.21 Hz, H-1), 4.98 (d, 1H, J=3.60 Hz, H-1), 5.64-5.84 (m, 13H, OH-2,3), 5.99 (d, 1H, J=5.82 Hz, OH-2), 7.13 (d, 2H, J=8.04 Hz, ═CHₘₑₜₐ), 7.49 (d, 2H, J=8.40 Hz, ═CHₒᵣₜₕₒ), 7.68 (s, 1H, ═CH-5ᵢₘ), 7.69 (s, 1H, ═CH-4ᵢₘ), 9.01 (s, 1H, ═CH-2ᵢₘ).

¹³C NMR (125 MHz, DMSO-d₆) δ: 20.7 (CH_{3Ts}), 35.8 (CH₃ᵢₘ), 49.8 (C6), 59.9 (C6), 69.6 (C5), 72.0 (C5), 72.3 (C3), 73.3 (C2), 81.5 (C4), 83.0 (C4), 101.8 (C1), 123.0 (═CHᵢₘ), 123.3 (═CHᵢₘ), 125.4 (Cₘₑₜₐ), 128.0 (Cₒᵣₜₕₒ), 137.0 (═CHᵢₘ), 137.7 (Cₚₐᵣₐ), 145.4 (Cᵢₚₛₒ).

### Example 2

### Synthesis of 6-(butylimidazolium)-6-deoxy-β-cyclodextrin tosylate

A mixture of 6-O-tosyl-β-cyclodextrin (2.578 g, 2.0 mmol) and 1-butylimidazole (0.745 g, 6.0 mmol) in DMF (5 mL) was stirred under nitrogen at 90° C. for 2 days. After cooling to room temperature, acetone (25 mL) was added to the resultant solution and vigorously stirred for 30 minutes. The solid formed was separated by filtration, washed with acetone and finally dried under vacuum to give a white solid (2.75 g, 96.6%); mp. 254° C. (dec.).

IR (KBr) ν: 3402, 2929, 1638, 1410, 1335, 1157, 1080, 1033, 945, 844, 756, 683, 578 cm⁻¹. MS (ESI, m/e, relative intensity %), 1241.60 (M⁺, 100), calcd. 1241.47; 171.30 (⁻OTs, 40), calcd. 171.17.

¹H NMR (500 MHz, DMSO-d₆) δ: 0.90 (t, 3H, J=7.21 Hz, CH₃), 1.27 (s, 2H, J=7.20 Hz, CH₂), 1.78 (q, 2H, J=7.02 Hz, CH₂), 2.29 (s, 3H, CH_{3Ts}), 2.83-2.89 (m, 1H, H-2′_{CD}), 3.04-3.07 (m, 1H, H-4′_{CD}) 3.22-3.38 (overlap with HDO, m, 12H, H-2_{CD} and H-4_{CD}), 3.54-3.64 (m, 25H, H-5_{CD}, H-3_{CD} and H-6_{CD}), 3.83 (t, 2H, CH₂), 4.00 (t, 1H, J=10.5 Hz, H-5′_{CD}), 4.14 (t, 2H, J =6.63 Hz, H-6′_{CD}), 4.30 (t, 1H, J=8.82 Hz, OH-6), 4.47 (t, 2H, J=5.22 Hz, OH-6), 4.54 (t, 3H, J=5.19 Hz, OH-6), 4.85 (d, 6H, J=3.21 Hz, H-1), 4.97 (d, 1H, J=3.60 Hz, H-1), 5.63-5.84 (m, 13H, OH-2 and OH-3), 5.98 (d, 1H, J=6.03 Hz, OH-2), 7.12 (d, 2H, J=8.04 Hz, ═CHₘₑₜₐ), 7.48 (d, 2H, J=7.62 Hz, ═CHₒᵣₜₕₒ), 7.72 (s, 1H, ═CH-5ᵢₘ), 7.78 (s, 1H, ═CH-4ᵢₘ), 9.09 (s, 1H, ═CH-2ᵢₘ).

¹³C NMR (125 MHz, DMSO-d₆) δ: 13.2 (CH₃), 18.8 (CH₂), 20.7 (CH₃), 30.6 (CH₂), 31.0 (CH₂), 49.9 (C6), 59.9 (C6), 69.6 (C5′), 71.7 (C5), 72.4 (C3), 73.0 (C2), 81.5 (C4), 83.2 (C4′), 101.9 (C1), 122.2 (═CHᵢₘ), 123.1 (═CHᵢₘ), 125.4 (Cₘₑₜₐ), 128.0 (Cₒᵣₜₕₒ), 136.6 (═CHᵢₘ), 137.5 (Cₚₐᵣₐ), 145.7 (Cᵢₚₛₒ).

### Example 3

### Synthesis of 6-deoxy-6-(octylimidazolium)-β-cyclodextrin tosylate

A mixture of 6-β-tosyl-,-cyclodextrin (2.578 g, 2.0 mmol) and 1-octylimidazole (1.082 g, 6.0 mmol) in DMF (5 mL) was stirred under nitrogen at 90° C. for 2 days. After cooling to room temperature, acetone (25 mL) was added to the resultant solution and vigorously stirred for 30 minutes. The solid formed was separated by filtration, washed with acetone and finally dried under vacuum to give a white solid (2.88 g, 98.0%); mp. 256° C. (dec.).

IR (KBr) ν: 3392, 2926, 1639, 1566, 1410, 1369, 1334, 1301, 1157, 1080, 1033, 943, 846, 756, 685, 575 cm-⁻¹. MS (ESI, m/e, relative intensity %), 1297.80 (M⁺, 100), calcd. 1297.53; 171.30 (⁻OTs, 48), calcd. 171.17.

¹H NMR (500 MHz, DMSO-d) δ: 0.85 (t, 3H, J=6.81 Hz, CH₃), 1.24 (m, 10H, CH₂), 1.78 (q, 2H, J=7.02 Hz, CH₂), 2.28 (s, 3H, CH_{3Ts}), 2.83-2.89 (m, 1H, H-2′_{CD}), 3.04-3.07 (m, 1H, H-4′_{CD}) 3.22-3.38 (overlap with HDO, m, 12H, H-2_{CD} and H-4_{CD}), 3.53-3.64 (m, 25H, H-5_{CD}, H-3_{D} and H-6_{CD}), 3.83 (t, 2H, CH₂), 3.96 (t, 1H, J=10.5 Hz, H-5′_{CD}), 4.13 (t, 2H, J=6.63 Hz, H-6′_{CD}), 4.30 (t, 1H, J=10.63 Hz, OH-6), 4.44 (s br, 2H, OH-6), 4.54 (s br, 3H, OH-6), 4.82 (s br, 6H, H-1), 4.95 (s br, 1H, H-1), 5.62-5.78 (m, 13H, OH-2 and OH-3), 5.95 (d, 1H, J=6.03 Hz, OH-2), 7.11 (d, 2H, J=7.62 Hz, ═CHₘₑₜₐ), 7.47 (d, 2H, J=8.01 Hz, ═CHₒᵣₜₕₒ), 7.71 (s, 1H, ═CH-5im), 7.77 (s, 1H, ═CH-4ᵢₘ), 9.07 (s, 1H, ═CH-2ᵢₘ).

¹³C NMR (125 MHz, DMSO-d₆) δ: 13.9 (CH₃), 20.7 (CH₃), 22.0 (CH₂), 25.5 (CH₂), 28.2 (CH₂), 28.4 (CH₂), 29.1 (CH₂), 30.6 (CH₂), 31.1 (CH₂), 49.9 (C6′), 59.9 (C6), 69.5 (C5′), 71.6 (C5), 72.4 (C3), 73.0 (C2), 81.5 (C4), 83.1 (C4′), 101.9 (C1), 122.2 (═CHᵢₘ), 123.0 (═CHᵢₘ), 125.4 (Cₘₑₜₐ), 128.0 (Cₒᵣₜₕₒ), 136.6 (═CHᵢₘ), 137.6 (Cₚₐᵣₐ), 145.7 (Cᵢₚₛₒ).

### Example 4

### Synthesis of 6-deoxy-6-{2-(2-ethoxyethoxy) ethylimidazolium}-β-cyclodextrin tosylate

A mixture of 6-O-tosyl-β-cyclodextrin (2.578 g, 2.0 mmol) and 2-(2-ethoxyethoxy)ethylimidazole (1.15 g, 6.0 mmol) in DMF (5 mL) was stirred under nitrogen at 90° C. for 2 days. After cooling to room temperature, acetone (25 mL) was added to the resultant solution and vigorously stirred for 30 minutes. The solid formed was separated by filtration, washed with acetone and finally dried under vacuum to give a white solid (2.87 g, 97.4%); mp. 254° C. (dec.).

IR (KBr) ν: 3393, 2928, 1638, 1410, 1368, 1335, 1302, 1157, 1119, 1080, 1033, 943, 845, 755, 683, 608, 577 cm⁻¹. MS (ESI, m/e, relative intensity %), 1301.60 (M⁺, 100), calcd. 1301.49; 171.30 (⁻OTs, 94), calcd. 171.17.

¹H NMR (500 MHz, DMSO-d₆) δ: 1.09 (t, 3H, J=6.84 Hz, CH₃), 2.28 (s, 3H, CH_{3Ts}), 2.83-2.89 (m, 1H, H-2′_{CD}), 3.04-3.07 (m, 1H, H-4′_{CD}) 3.22-3.48 (overlap with HDO, m, 18H, OCH₂, H-2_{CD} and H-4_{CD}), 3.51-3.68 (m, 27H, OCH₂, H-5_{CD}, H-3_{CD} and H-6_{CD}), 3.78 (t, 2H, J=4.41 Hz, CH₂), 3.96 (t, 1H, J=10.5 Hz, H-5′_{CD}), 4.34 (t, 2H, J=6.63 Hz, H-6′_{CD}), 4.45 (s br, 2H, OH-6), 4.52 (s br, 4H, OH-6), 4.84 (d, 6H, J=2.82 Hz, H-1), 4.95 (d, 1H, J=3.21 Hz, H-1), 5.64-5.78 (m, 13H, OH-2 and OH-3), 5.96 (d, 1H, J=6.42 Hz, OH-2), 7.11 (d, 2H, J=8.01 Hz, ═CHₘₑₜₐ), 7.48 (d, 2H, J=8.04 Hz, ═CH_{ortho),} 7.73 (s, 2H, ═CH-4,5ᵢₘ), 9.01 (s, 1H, ═CH-2ᵢₘ).

¹³C NMR (125 MHz, DMSO-d₆) δ: 15.0 (CH₃), 20.7 (CH₃), 49.8 (C6′), 59.9 (C6), 65.5 (OCH₂), 68.0 (OCH₂), 68.9 (OCH₂), 69.5 (C5′), 71.6 (C5), 72.4 (C3), 73.0 (C2), 81.5 (C4), 83.1 (C4′), 101.9 (C1), 122.6 (═CHᵢₘ), 122.8 (═CHᵢₘ), 125.4 (Cₘₑₜₐ), 128.0 (Cₒᵣₜₕₒ), 137.0 (═CHᵢₘ), 137.5 (Cₚₐᵣₐ), 145.7 (Cᵢₚₛₒ).

### Example 5

### Synthesis of mono-6-deoxy-6-pyridinium-β-cyclodextrin tosylate

A mixture of mono-6-deoxy-6-(p-toluenesulfonyl)-β-cyclodextrin (1.289 g, 1.0 mmol) and pyridine (0.237 g, 3.0 mmol) in DMF (5 mL) was stirred under nitrogen at 80° C. for 2 days. After cooling to room temperature, acetone (25 mL) was added to the resultant solution and vigorously stirred for 30 minutes. The solid formed was separated by filtration, washed with acetone and finally dried under vacuum to give white solid (1.163 g, 85.0%), m.p. 239-241° C.

IR (KBr) ν: 3394, 2925, 1636, 1414, 1369, 1335, 1158, 1080, 1032, 943, 682, 577 cm⁻. MS (ESI, m/e, relative intensity %), 1196.60 (M⁺, 100), calcd. 1196.42; 171.30 (⁻OTs, 100), calcd. 171.01.

¹H NMR (300 MHz, DMSO-d₆) δ: 2.29 (s, 3H, CH_{3Ts}), 3.12-3.47 (overlap with HDO, m, 14H, H-2_{CD} and H-4_{CD}), 3.55-3.67 (m, 26H, H-5_{CD}, H-3_{CD} and H-6_{CD}), 3.86-3.96 (m, 2H, H-6_{CD}), 4.18 (t, 1H, J =10.02, 10.83 Hz, OH-6), 4.28 (t, 1H, J=6.03, 5.61 Hz, OH-6), 4.45 (t, 1H, J=5.22, 5.61 Hz, OH-6), 4.54 (t, 2H, J=5.61, 5.22 Hz, OH-6), 4.60 (t, 1H, J=5.61, 7.62 Hz, OH-6), 4.77-4.88 (m, 6H, H-1), 5.02 (d, 1H, J=6.0 Hz, H-1), 5.58 (d, 1H, J=2.01 Hz, OH-3), 5.63-5.87 (m, 12H, OH-2 and OH-3), 6.06 (d, 1H, J=6.0 Hz, OH-2), 7.10 (d, 2H, J=7.62 Hz, ═CH_{metaTs}), 7.48 (d, 2H, J=8.40 Hz, ═CH_{orthoTs}), 8.13 (t, 2H, J=7.23, 6.84 Hz, ═CH-3_{pyr}), 8.64 (t, 1H, J=8.04, 7.68 Hz, ═CH-4_{pyr}), 9.01 (d, 2H, J=6.03 Hz, ═CH-2_{pyr}).

¹³C NMR (125 MHz, DMSO-d₆) δ: 20.7 (CH_{3Ts}), 58.7 (C6′), 59.8 (C6), 60.8 (C6), 61.6 (C6), 70.2 (C5′), 71.3, 71.9, 72.1, 72.3, 73.0, 73.4 (C5, C3, C2), 80.6, 81.4, 82.9 (C4), 83.6 (C4′), 100.9 (C1′), 101.8, 101.9, 102.3 (C1), 125.4 (C_{metaTs}), 127.9 (C3_{pyr}), 128.0 (C_{orthoTs}), 137.5 (C_{paraTs}), 145.4 (C_{ipsoTs}), 145.5 (C⁴_{pyr}), 146.1 (C2_{pyr}).

### Example 6

### Synthesis of mono-6-allylammonium-6-deoxy-β-cyclodextrin tosylate

A solution of mono-6-deoxy-6-(p-toluenesulfonyl)-β-cyclodextrin (2.578 g, 2.0 mmol) and allylamine (0.343 g, 6.0 mmol) in dimethyl formamide (5 mL) was refluxed for 5 hours under nitrogen. After cooling to room temperature, acetone (25 mL) was added to the resultant solution and stirred for 30 minutes. The white solid formed was filtered and dried under vacuum over night to give the desired product (2.48 g, 92.1 %); mp. 249° C. (dec.).

IR (KBr) ν: 3426, 2926, 1638, 1445, 1411, 1334, 1157, 1080, 1032, 943, 760, 700, 639, 575 cm⁻¹. MS (ESI, m/e, relative intensity %), 1174.40 (MH⁺, 100), calcd. 1174.42; 171.30 (⁻OTs, 26), calcd. 171.17.

¹H NMR (500 MHz, DMSO-d₆) δ: 2.29 (s, 3H, CH_{3Ts}), 2.85 (t, 1H, J=8.82 Hz, H-2′_{CD}), 3.10 (d, 1H, J=12.05 Hz, H-4′_{CD}) 3.32-3.54 (overlap with HDO, m, 14H, H-2_{CD}, H-4_{CD} and CH₂), 3.60-3.63 (m, 27H, H-5_{CD}, H-3_{CD} and H-6_{CD}), 3.80 (t, 1H, H-3′_{CD}), 4.50 (s br, 1H, OH-6), 4.83 (d, 6H, J=3.65 Hz, H-1), 4.87 (d, 1H, J=3.25 Hz, H-1), 5.16-5.38 (m, 2H, ═CH₂), 5.67 (s br, 6H, OH-3), 5.73 (s br, 8H, OH-2 and OH-3), 5.81-5.87 (m, 1H, —CH═), 7.12 (d, 2H, J=8.30 Hz, ═CHₘₑₜₐ), 7.48 (d, 2H, J=7.85 Hz, ═CHₒᵣₜₕₒ).

¹³C NMR (125 MHz, DMSO-d₆) δ: 20.7 (CH₃), 40.9 (CH₂), 50.6 (C6′), 59.9 (C6), 69.0 (C5′), 72.0 (C5), 72.2 (C3), 73.0 (C2), 81.2 (C4), 83.6 (C4′), 101.9 (C1), 119.8 (═CH₂), 125.4 (Cₘₑₜₐ), 128.1 (Cₒᵣₜₕₒ), 130.8 (—=), 137.9 (Cₚₐᵣₐ), 145.1 (Cᵢₚₛₒ).

### Example 7

### Synthesis of mono-6-deoxy-6-(n-propylammonium)-β-cyclodextrin tosylate

A solution of mono-6-deoxy-6-(p-toluenesulfonyl)-β-cyclodextrin (2.578 g, 2.0 mmol) and n-propylamine (0.355 g, 6.0 mmol) in dimethyl formamide (5 mL) was refluxed for 5 hours under nitrogen. After cooling to room temperature, acetone (25 mL) was added to the resultant solution and stirred for 30 minutes. The white solid formed was filtered and dried under vacuum over night to give the desired product (2.64 g, 97.9%); mp. 260° C. (dec.).

IR (KBr) ν: 3397, 2928, 1638, 1410, 1334, 1301, 1155, 1080, 1032, 943, 759, 702, 577 cm⁻¹. MS (ESI, m/e, relative intensity %), 1176.50 (MH⁺, 100), calcd. 1176.44; 171.30 (⁻OTs, 14), calcd. 171.17.

¹H NMR (500 MHz, DMSO-d₆) δ: 0.85 (t, 3H, J=7.62 Hz, CH₃), 1.48 (s, 2H, J=7.23 Hz, CH₂), 2.29 (s, 3H, CH_{3Ts}), 2.63 (t, 2H, J=7.23 Hz, CH₂), 2.89 (t, 1H, J=8.82 Hz, H-2′_{CD}), 3.12 (d, 1H, J=11.62 Hz, H-4′_{CD}) 3.34-3.44 (overlap with HDO, m, 14H, H-2_{CD} and H-4_{CD}), 3.54-3.63 (m, 27H, H-5_{CD}, H-3_{CD} and H-6_{CD}), 3.78 (t, 1H, H-3′_{CD}), 4.48 (s br, 6H, OH-6), 4.83 (s, 6H, H-1), 4.86 (s, 1H, H-1), 5.67-5.79 (m, 14H, OH-2 and OH-3), 7.12 (d, 2H, J=8.04 Hz, ═CHₘₑₜₐ), 7.48 (d, 2H, J=7.62 Hz, ═CHₒᵣₜₕₒ).

¹³C NMR (125 MHz, DMSO-d₆) δ: 11.2 (CH₃), 20.7 (CH₃), 30.6 (CH₂), 34.5 (CH₂), 50.2 (C6′), 59.9 (C6), 69.0 (C5′), 72.0 (C5), 72.4 (C3), 73.0 (C2), 81.5 (C4), 83.5 (C4′), 101.9 (C1), 125.4 (Cₘₑₜₐ), 128.0 (Cₒᵣₜₕₒ), 137.7 (Cₚₐᵣₐ), 145.4 (Cᵢₚₛₒ).

### Example 8

### Synthesis of mono-6-deoxy-6-(n-butylammonium)-β-cyclodextrin tosylate

A solution of mono-6-deoxy-6-(p-toluenesulfonyl)-β-cyclodextrin (2.578 g, 2.0 mmol) and n-butylamine (0.349 g, 6.0 mmol) in dimethyl formamide (5 mL) was refluxed at 90° C. for 5 hours under nitrogen. After cooling to room temperature, acetone (25 mL) was added to the resultant solution and stirred for 30 minutes. The white solid formed was filtered and dried under vacuum over night to give the desired product (2.65 g, 97.3%); mp. 263° C. (dec.).

IR (KBr) ν: 3382, 2928, 1640, 1415, 1369, 1335, 1302, 1157, 1080, 1032, 943, 756, 704, 576 cm⁻¹. MS (ESI, m/e, relative intensity %), 1190.40 (MH⁺, 100), calcd. 1190.46; 171.30 (⁻OTs, 28), calcd. 171.17.

¹H NMR (500 MHz, DMSO-d₆) δ: 0.85 (t, 3H, J=7.23 Hz, CH₃), 1.27 (s, 2H, J=7.65 Hz, CH₂), 1.41 (s, 2H, J=7.62 Hz, CH₂), 2.28 (s, 3H, CH_{3Ts}), 2.61 (t, 2H, J=7.64 Hz, CH₂), 2.83 (t, 1H, J=8.82 Hz, H-2′_{CD}), 3.07 (d, 1H, J=11.22 Hz, H-4′_{CD}) 3.31-3.46 (overlap with HDO, m, 12H, H-2_{CD} and H-4_{CD}), 3.54-3.63 (m, 27H, H-5_{CD}, H-3_{CD} and H-6_{CD}), 3.75 (t, 1H, H-3′_{CD}), 4.50 (s br, 6H, OH-6), 4.83 (s, 6H, H-1), 4.85 (s, 1H, H-1), 5.64-5.81 (m, 14H, OH-2 and OH-3), 7.12 (d, 2H, J=8.04 Hz, ═CHₘₑₜₐ), 7.48 (d, 2H, J=8.04 Hz, ═CHₒᵣₜₕₒ).

¹³C NMR (125 MHz, DMSO-d₆) δ: 13.7 (CH₃), 19.6 (CH₂), 20.7 (CH₃), 30.6 (CH₂), 48.3 (C6′), 59.8 (C6), 69.2 (C5′), 72.0 (C5), 72.4 (C3), 73.0 (C2), 81.5 (C4), 83.5 (C4′), 101.9 (C1), 125.4 (Cₘₑₜₐ), 128.0 (Cₒᵣₜₕₒ), 137.7 (Cₚₐᵣₐ), 145.4 (Cᵢₚₛₒ).

### Example 9

### Synthesis of mono-6-deoxy-6-(n-pentylammonium)-β-cyclodextrin tosylate

A solution of mono-6-deoxy-6-(p-toluenesulfonyl)-β-cyclodextrin (2.578 g, 2.0 mmol) and n-pentylamine (0.532 g, 6.0 mmol) in dimethyl formamide (5 mL) was refluxed at 90° C. for 5 hours under nitrogen. After cooling to room temperature, acetone (25 mL) was added to the resultant solution and stirred for 30 minutes. The white solid formed was filtered and dried under vacuum over night to give the desired product (2.65 g, 96.3%); 266° C. (dec.).

IR (KBr) ν: 3402, 2922, 1639, 1418, 1370, 1335, 1302, 1157, 1080, 1031, 943, 755, 705, 577 cm⁻¹. MS (ESI, m/e, relative intensity %), 1204.50 (MH⁺, 100), calcd. 1204.47; 171.3 (⁻OTs, 16), calcd. 171.17.

¹H NMR (500 MHz, DMSO-d₆) δ: 0.86 (t, 3H, J=6.42 Hz, CH₃), 1.25 (s br, 4H, CH₂), 1.47 (s br, 2H, CH₂), 2.29 (s, 3H, CH_{3Ts}), 2.63 (t, 2H, CH₂), 2.85 (t, 1H, H-2_{CD}), 3.12 (d, 1H, J=11.22 Hz, H-4_{CD}) 3.32-3.45 (overlap with HDO, m, 12H, H-2_{CD} and H-4_{CD}), 3.54-3.65 (m, 27H, H-5_{CD}, H-3_{CD} and H-6_{CD}) 3.75 (t, 1H, H-3′_{CD}), 4.48 (s br, 6H, OH-6), 4.84 (s, 6H, H-1), 4.86 (s, 1H, H-1), 5.66-5.81 (m, 14H, OH-2 and OH-3), 7.12 (d, 2H, J=8.43 Hz, ═CHₘₑₜₐ), 7.48 (d, 2H, J=8.04 Hz, ═CHₒᵣₜₕₒ).

¹³C NMR (125 MHz, DMSO-d₆) δ: 13.8 (CH₃), 20.7 (CH₃), 21.8 (CH₂), 28.5 (CH₂), 30.6 (CH₂), 48.3 (C6′), 59.9 (C6), 68.8 (C5′), 72.0 (C5), 72.4 (C3), 73.0 (C2), 81.4 (C4), 83.5 (C4′), 101.9 (C1), 125.4 (Cₘₑₜₐ), 128.1 (Cₒᵣₜₕₒ), 137.9 (Cₚₐᵣₐ), 145.1 (Cᵢₚₛₒ)

### Example 10

### Synthesis of mono-2-allylammonium-2-deoxy-β-cyclodextrin tosylate

A solution of mono-2-deoxy-2-(p-toluenesulfonyl)-β-cyclodextrin (1.289 g, 1.0 mmol) and allyl amine (2 g, 35.0 mmol) in dimethyl sulfoxide (3 mL) was refluxed for 6 days under nitrogen. The resultant solution was cooled to room temperature, added with acetone (25 mL) and stirred for 30 minutes. The white solid formed was filtered and dried under vacuum over night to give a desired product (1.25 g, 92.9%); mp. 250° C. (dec.).

IR (Ker) ν: 3438, 2929, 1639, 1448, 1413, 1335, 1158, 1679, 1031, 942, 761, 701, 640, 574 cm⁻¹. MS (ESI, m/e, relative intensity %), 1174.40 (MH⁺, 100), calcd. 1174.42; 171.30 (⁻OTs, and 26), calcd. 171.01.

¹H NMR (500 MHz, DMSO-d₆) δ: 2.29 (s, 3H, CH₃), 3.25-3.46 (m, 14H, CH-2,4 overlap with HOD), 3.55-3.98 (m, 28H, CH-3,5,6) 4.37-4.65 (m, 7H, OH-6), 4.80-4.95 (m, 7H, CH-1), 5.16 (d, 1H, J=10.2 Hz, OH-3), 5.30 (1H, d, J=17.1 Hz, OH-3), 5.56-5.60 (m, 2H, ═CH₂), 5.63-5.80 (m, 12H, OH-2,3), 5.81-5.86 (m, 1H, —=), 7.11 (d, 2H, J=7.85 Hz, ═CHₘₑₜₐ-aromatic), 7.48 (d, 2H, J=8.30 Hz, ═CHₒᵣₜₕₒ-aromatic).

¹³C NMR (125 MHz, DMSO-d₆) δ: 20.8 (CH₃), 30.7 (CH₂), 48.8 (C-6), 58.2 (C-6), 59.7 (C-6), 70.1 (C-5), 71.7-73.3 (m, C-2,3,5), 75.3 (C-3), 76.8 (C-2), 79.9 (C-4), 81.0-82.0 (m, C-4), 101.6-102.2 (m, C-1), 103.8 (C-1), 125.5 (═CH₂), 128.0 (Cₘₑₜₐ), 130.9 (Cₒᵣₜₕₒ), 137.6 (—CH═), 137.6 (Cₚₐᵣₐ), 145.7 (Cᵢₚₛₒ).

### Example 11

### Synthesis of mono-2-deoxy-2-(n-propylammonium)-β-cyclodextrin tosylate

A solution of mono-2-deoxy-2-(p-toluenesulfonyl)-β-cyclodextrin (6.20 g, 4.81 mmol) and n-propyl amine (9.950 g, 168.3 mmol) in dimethyl sulfoxide (10 mL) was refluxed for 6 days under nitrogen. The resultant solution was cooled to room temperature, added with acetone (50 mL) and stirred for 30 minutes. The white solid formed was filtered and dried under vacuum over night to give a desired product (5.95 g, 91.7%); mp. 255° C. (dec.).

IR (KBr) ν: 3395, 2929, 1639, 1411, 1335, 1302, 1154, 1079, 1033, 944, 758, 701, 576 cm⁻¹. MS (ESI, m/e, relative intensity %), 1176.70 (MH⁺, 100), calcd. 1176.44; 171.30 (⁻OTs, and 26), calcd. 171.01.

¹H NMR (500 MHz, DMSO-d₆) δ: 0.87 (t, 3H, J=7.23 Hz, CH₃), 1.54 (q, 2H, J=7.23 Hz, CH₂), 2.28 (s, 3H, CH₃), 3.29-3.41 (m, 15H, CH₂, CH-2 and CH-4 overlap with HOD), 3.54-3.70 (m, 27H, CH-5, CH-3, CH-6), 3.98 (d, 1H, J=12.45 Hz, CH-3 with ⁺NH₂ group), 4.46 (s, br, 7H, OH-6), 4.67 (d, 1H, J=6.81 Hz, CH-2 with ⁺NH₂ group), 4.82 (d, 6H, J=2.82 Hz, CH-1), 4.91 (d, 1H, J=3.60 Hz, CH-1 with ⁺NH₂ group), 5.60 (t, 1H, J=Hz, OH-3), 5.67 (s, 6H, OH-2), 5.70 (t, 5H, J=6.42 Hz, OH-3), 5.85 (s, br, 1H, OH-3 with +NH₂ group), 7.11 (d, 2H, J=8.04 Hz, ═CHₘₑₜₐ-aromatic), 7.48 (d, 2H, J=8.04 Hz, ═CHₒᵣₜₕₒ-aromatic).

¹³C NMR (125 MHz, DMSO-d₆) δ: 11.3 (CH₃), 20.5 (CH₂), 20.8 (CH₃), 48.1 (CH₂), 58.9 (C-6′), 59.8-60.2 (m, C-6), 69.6 (C-5′), 71.7-73.2 (m, C-2, C-3, C-5), 74.9 (C-3′), 76.6 (C-2′), 79.7 (C-4′), 81.0-82.0 (m, C-4), 101.6-102.2 (m, C-1), 103.6 (C-1′), 124.5 (C-3,5_{Ts}), 128.0 (C-2,6^{Ts}), 137.6 (C-4_{Ts}), 145.7 (C-1_{Ts}).

### Example 12

### Synthesis of mono-6-deoxy-6-(dimethyl n-butyl ammonium) permethylated β-cyclodextrin iodide

In a three-neck, 250 mL round-bottomed flask equipped with a condenser, nitrogen inlet, stopper and magnetic stirrer was placed mono-6-deoxy-6-n-butylammonium-β-cyclodextrin (6.82 g, 5 mmol) obtained in Experiment 8, which had been dried at 60° C. for 1 d under vacuum, and dry dimethylformamide (100 mL). The solution was stirred and cooled to 0° C. by ice-acetone bath and then sodium hydride (5.28 g, 0.22 mol, 60% dispersion in mineral oil) was added. After maintaining the temperature for 2 h, methyl iodide (14.0 ml, 0.22 mol) was added and the mixture was stirred at 0° C. for 1 h. The temperature was raised to 10° C. and continuous stirred for 1 h and then to room temperature for 3 h. After the addition of ethanol (18 mL) and saturated aqueous sodium chloride solution (200 mL) containing Na₂S₂O₃, the mixture was extracted with ethyl acetate (3×200 mL). The organic layer was dried over Na₂SO₄ overnight, filtered and removed by rotatory evaporator followed by high vacuum overnight to give a foam solid (7.30 g, 89.8%), mp. 79.0-81.0° C.

IR (KBr) ν: 2931, 2831, 1654, 1462, 1370, 1323, 1159, 1105, 1038, 970, 908.5, 856, 752, 705, 565 cm⁻¹. MS (ESI, m/e, relative intensity %) 1498.9 (M⁺, 100), calcd. 1498.8; 126.8 (I⁻, 100), calcd. 126.9.

¹H NMR (300 MHz, CDCl₃) δ 0.93 (t, 3H, J=7.20 Hz, CH₃), 1.36 (q, 2H, J=7.23 Hz, CH₂), 1.70 (q, 2H, J=6.84, CH₂), 3.06-3.21 (m, 7H, H-2), 3.27-3.57 (m, 29H, H-3,4,5, CH₂N(CH₃)₂), 3.30 (s, 21H, OCH₃), 3.41 (s, 18H, OCH₃), 3.52 (s, 21H, OCH₃), 3.61-3.78 (m, 12H, H-6), 4.25 (t, 2H, J=8.82 Hz, H-6), 4.91-5.10 (m, 7H, H-1).

¹³C NMR (75 MHz, CDCl₃) δ 13.7 (CH₃), 19.3 (CH₂), 24.7 (CH₂), 51.8 (NCH₂), 57.8-61.2 (m, OCH₃), 64.1 (C-5), 65.9 (C-5), 68.1 (C-5), 70.6-71.7 (m, C-5,6), 72.8 (C-6), 75.9 (C-6), 78.4 (C-4), 80.0-82.4 (m, C-4,2,3), 96.0 (C-1), 97.9 (C-1), 98.8 (C-1), 99.1 (C-1), 99.2 (C-1), 99.7 (C-1).

### Example 13

### Synthesis of mono-6-amino-6-deoxy-β-cyclodextrin

A mixture of mono-6-azido-6-deoxy-β-cyclodextrin (5.80 g, 5 mmol), prepared from 6-O-tosyl-β-cyclodextrin using previously reported procedure by R. S. Petter, J. S. Salek, C. T. Sikorski, G. Kumaravel and F-T. Lin [16], and triphenyl phosphine (1.443 g, 5.5 mmol) in DMF (10 mL) was stirred at room temperature for 2 hours. The resultant solution was added deionized water (1.0 mL) and reflux for 2 hours. The solution was added acetone to precipitate the white solid and the solid was filtered, washed with acetone and finally dried under high vacuum for overnight to give pure product 5.50 g (97.0%), mp. 275-277° C. (dec.).

IR (KBr) ν: 3428, 3311, 2928, 1659, 1438, 1414, 1389, 1369, 1334, 1156, 1080, 1030, 947, 755, 707, 609, 580 cm⁻. MS (ESI, m/e, relative intensity %), 1134.50 (M+H⁺, 100), calcd. 1134.30.

¹H NMR (300 MHz, DMSO-d₆) δ: 3.34 (m, 30H, H-3,5, H-6, NH₂), 3.56-3.65 (m, 14H, H-2,4), 4.43-4.46 (m, 6H, OH-6), 4.83 (d, 6H, J=2.0 Hz, H-1), 4.89 (d, 1H, J=2.0 Hz, H-1^{A}), 5.61-5.77 (m, 14H, OH-2,3).

¹³C NMR (75 MHz, DMSO-d₆) δ: 59.9 (C-6), 72.0 (C2), 72.4 (C-3), 73.0 (C-5), 81.6, 82.3 (C-4), 101.9 (C-1)

### Example 14

### Synthesis of mono-6-deoxy-6-(trimethyl ammonium) permethylated β-cyclodextrin iodide

In a three-neck, 250 mL round-bottomed flask equipped with a condenser, nitrogen inlet, stopper and magnetic stirrer was placed mono-6-amino-6-deoxy-β-cyclodextrin (2.268 g, 2.0 mmol) obtained in Experiment 13, which had been dried at 60° C. for 1 d under vacuum, and dry dimethylformamide (50 mL). The solution was stirred and cooled to 0° C. by ice-acetone bath and then sodium hydride (3.68 g, 92.0 mmol, 60% dispersion in mineral oil) was added. After maintaining the temperature for 2 h, methyl iodide (13.058 g, 92.0 mmol) was added and the mixture was stirred at 0° C. for 1 h. The temperature was raised to 10° C. and continuous stirred for 1 h and then to room temperature for 3 h. After the addition of ethanol (5 mL) and saturated aqueous sodium chloride solution (100 mL) containing Na₂S₂O₃, the mixture was extracted with ethyl acetate (3×100 mL). The organic layer was dried over Na₂SO₄ overnight, filtered and removed by rotatory evaporator followed by high vacuum overnight to give a foam solid (2.67 g, 84.2%), mp. 89.5-91.5° C.

IR (KBr) ν: 2929, 2833, 1459, 1369, 1232, 1192, 1159, 1103, 1037, 970, 893, 854, 752, 705, 555 cm⁻. MS (ESI, m/e, relative intensity %), 1456.90 (M⁺, 100), calcd. 1456.75; 127.30 (I⁻, 100), calcd. 126.91.

¹H NMR (500 MHz, CDCl₃) δ: 1.24 (s, 9H, CH₃), 3.15-3.27 (m, 7H, H-5), 3.33-3.70 (m, 21H, H-3,6) 3.36-3.40 (m, 18H, OCH₃), 3.42-3.58 (m, 21H, OCH₃), 3.60-3.63 (m, 21H, OCH₃), 3.72-3.90 (m, 12H, H-2,4), 4.10 (t, 1H, J=4.31 Hz, H-4), 4.33 (t, 1H, J=5.67 Hz, H-4), 4.98-5.22 (m, 7H, H-1).

¹³C NMR (125 MHz, CDCl₃) δ: 29.6 (CH₃), 54.6, 58.0-61.4 (m, 2-CH₃, 6-CH₃, 3-CH₃), 67.4, 68.3, 70.7-71.8 (m, C-5, C-6), 76.4, 78.3, 80.2-82.1 (m, C-4, C-3, C-3), 83.7, 96.1, 98.1, 98.9, 99.2, 99.4, 99.8, 100.1 (C-1).

### Example 15

### Synthesis of 6-deoxy-6-(methylimidazolium)-β-cyclodextrin chloride, (Example of Exchange of ⁻OTs with other Anions)

Mono-6-deoxy-6-(methylimidazolium)-β-cyclodextrin tosylate obtained in Experiment 1 (1.09 g, 0.8 mmol) was dissolved in 50 ml deionised water. An amberlite 900 (Cl) resin was used for anionic exchange to obtain a yellow crystalline solid (0.982 g, 100%); mp. 226.8-227.8° C. (dec.).

Elemental analysis, Calcd C: 42.84%, H: 6.34% N: 2.17% S: 2.75%, Found C: 42.83% H: 5.97% N: 2.22% S: 2.87%; MALDI-TOF: 1199.1831 (M+], Calcd. 1200.1920; IR (KBr) ν: 3410.4, 1639.7, 1410, 1158.1, 1079.8, 1030.0, 998.6 cm⁻.

¹H NMR (400 MHz, DMSO-d6) δ: 3.23-3.49 (m, overlap with water-shift of DMSO-d6, m, 15H, βCD H-2 & H-4, imidazolium N- CH₃), 3.54-3.84 (m, 24H, βCD H-6_{a, b}, H-3 & H-5), 4.49-4.57 (m, 5H, βCD OH-6), 4.77-4.97 (m, 6H, βCD H-1), 5.66-5.81 (m, 12H, βCD OH-2 & OH-3), 7.70 (s, 2H, imidazolium C4-H, C5-H), 9.07 (s, 1H, imidazolium C2-H).

¹³C NMR (100 MHz, DMSO-d) δ: 137.08, 123.34, 123.01 (imidazolium C2, C5 & C4 respectively), 101.86 (βCD C1), 81.45 (βCD C4), 72.78 (βCD C3), 72.11 (βCD C2), 71.96 (βCD C5), 59.84 (βCD C6), 35.79 (imidazolium N—C).

### Example 16

### Application of the Ionic CDS in Asymmetric Synthesis

A solution of 6-deoxy-6-(methylimidazolium)-β-cyclodextrin tosylate (2.0 g, 1.458 mmol) in water/MeOH (5 ml: 2 mL)) and 4-fluorobenzaldehyde (0.180 g, 1.458 mmol) was stirred for 24 hours to form an inclusion complex. Tetraallyltin (0.103 g, 0.365 mmol) was added to the complex and stirred for 24 hours at room temperature. The reaction mixture was extracted with dichloromethane (3×5 mL) and the dichloromethane layer was dried (Na₂SO₄ anhydrous) and evaporated off. The residue was purified by kugelrohr distillation to give the desired product (0.210 g, 86.64%), oven temp. 100° C./2.0 mm Hg.

¹H NMR (300 MHz, CDCl₃) δ: 1.87 (bs, 1H, OH), 2.41-2.54 (m, 2H, CH₂), 4.72 (dd, J=5.6, 7.2 Hz, 1H, CHOH), 5.12-5.19 (m, 2H, CH═CH₂), 5.72-5.86 (m, 1H, CH═CH₂), 7.03 (t, J=8.8 Hz, 2H, aromatic Hₘ), 7.33 (dd, JHH=8.4 Hz, JHF=5.6 Hz, 2H, aromatic Hₒ). ¹³C NMR (75 MHz, CDCl₃ δ: 43.6 (C2), 72.7 (C1), 115.0 (C4), 118.2 (C3), 127.5 (C3′), 134.1 (C2′), 139.6 (C1′), 162.0 (C4′).

While particular embodiments of the present invention have been described in the foregoing, it is to be understood that other embodiments are possible within the scope of the invention and are intended to be included herein. The invention is to be considered limited solely by the scope of the appended claims.

### REFERENCES

1. E. Schneiderman and A. M. Stalcup, J. Chromatogr. B, 2000, 745, 83-102.
2. Z. Juvancz, TrAC., 2002, 21(5), 379-388.
3. K. W. Phinney and L. C. Sander, Anal. Bioanal. Chem., 2002, 372, 101-108.
4. S. Wren, Chromatographia, 2001, 54, S5-S96.
5. R. Bressole, M. Audran, T. N. Pham, and J. J. Vallon, J. Chromotogr. B, 1996, 687, 303-336.
6. J. Szeman, K. Ganzler, A. Salgo, and J. Szejtli, J. Chromatogr. A, 1996, 728, 423-431.
7. P. K. Owens, A. F. Fell, M. W. Coleman, and J. C. Berridge, J. Chromatogr. A, 1998, 797, 149-164.
8. P. K. Owens, A. F. Fell, M. W. Coleman, and J. C. Berridge, J. Chromatogr. A, 1998, 797, 187-195.
9. S. A. C. Wren and R. C. Rowe, J. Chromatogr. 1992, 603, 235-241.
10. S. Terabe, K. Otsuka and H. Nishi, J. Chromatogr. A, 1994, 666, 295-319.
11. S. Terabe, H. Ozaki, K. Otsuka, and T. Ando, J. Chromatogr. 1985, 332, 211.
12. S. Fanali and Z. Aturki, J. Chromatogr. A, 1995, 694, 297-305.
13. Y. Tanaka, Chromatography, 2002, 23 (1), 13-23.
14. Y. Tanaka and S. Terabe, J. Chromatogr. A, 1997, 781, 151-160.
15. Y. Matsui and A. Okimoto, Bull. Chem. Soc. Jpn., 1978, 51, 3030-3034.
16. R. S. Petter, J. S. Salek, C. T. Sikorski, G. Kumaravel and F-T. Lin, J. Am. Chem. Soc., 1990, 122, 3860-3868.
17. S. Terabe, TrAC., 1989, 8, 129-131.
18. A. Nardi, A. Eliseev, P. Bocek and S. Fanali, J. Chromatogr., 1993, 638, 247-253.
19. B. Chankvetadze, G. Schulte, and G. Blaschke, J. Chromatogr. A., 1996, 732, 183-187.
20. U. B. Nair and D. W. Armstrong, Microchem. Journal, 1997, 57, 199-217.
21. A. R. Khan, P. Forgo, K.J. Stine and V. T. D'Souza, Chem. Rev., 1998, 98, 1977-1996.
22. B. Brady, N. Lynam, T. O'Sullivan, C. Ahern, R. Darcy, Org. Synth., 2000, 77, 220-224.
23. T. Murakami, K. Harata, and S. Morimoto, Tetrahedron Lett., 1987, 28, 321-324.

1. A cationic oligomer of a saccharide of the general formula (I): 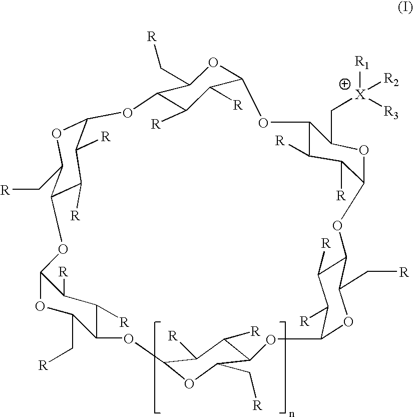
wherein:
n=0 to 8;
X is nitrogen or phosphorus;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy(C₁-C₂₀)alkyl, aryl, or aryl(C₁-C₂₀)alkyl; and
R₁, R₂ and R₃ are each independently selected from the group consisting of hydrogen, linear or branched (C₁-C₂₀)alkyl, linear or branched (C₁-C₂₀)alkenyl, linear or branched (C₁-C₂₀) alkynyl, and cycloalkyl; or
R₁is absent, and R₂ and R₃ are taken together with X to form a ring having the following structure: 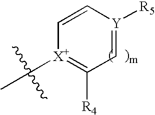
wherein m=0 or 1;
Y is carbon or nitrogen;
R₄ is hydrogen, linear or branched (C₁-C₂₀)alkyl, linear or branched (C₁-C₂₀)alkenyl, linear or branched (C₁-C₂₀)alkynyl, or cycloalkyl; and
R₅ is hydrogen, 2-(2-ethoxyethoxy)ethyl, linear or branched (C₁-C₂₀)alkyl, linear or branched (C₁-C₂₀)alkenyl, linear or branched (C₁-C₂₀)alkynyl, cycloalkyl, or NR₆R₇, wherein R₆ and R₇ are each independently selected from the group consisting of hydrogen, linear or branched (C₁-C₂₀)alkyl, linear or branched (C₁-C₂₀)alkenyl, linear or branched (C₁-C₂₀) alkynyl, and cycloalkyl.

2. The cationic oligomer of a saccharide according to claim 1, wherein R₁, R₂ and R₃ are each independently selected from the group consisting of hydrogen, linear or branched (C₁-C₂₀)alkyl, linear or branched (C₁-C₂₀)alkenyl, linear or branched (C₁-C₂₀)alkynyl, and cycloalkyl.

3. The cationic oligomer of a saccharide according to claim 2, wherein X is nitrogen.

4. The cationic oligomer of a saccharide according to claim 2, wherein X is phosphorus.

5. The cationic oligomer of a saccharide according to claim 1, wherein R₁ is absent, R₂ and R₃ form a ring, X is nitrogen, Y is nitrogen, and m is 0.

6. The cationic oligomer of a saccharide according to claim 1, wherein R₁ is absent, R₂ and R₃ form a ring, X is nitrogen, Y is carbon, and m is 1.

7. A cationic oligomer of a saccharide of the general formula (I): 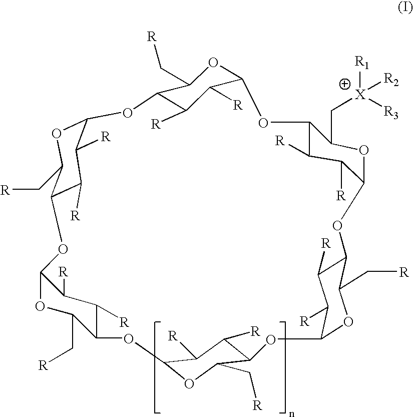
wherein:
n=0 to 8;
X is nitrogen or phosphorus;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂₀)alkyl, hydroxy(C₁-C₂₀)alkyl, carboxy(C₁-C₂₀)alkyl, aryl, or aryl(C₁-C₂₀alkyl; and
R₁, R₂ and R₃ are each independently selected from the group consisting of hydrogen, linear or branched (C₁-C₂₀)alkyl, linear or branched (C₁-C₂₀)alkenyl, linear or branched (C₁-C₂₀) alkynyl, and cycloalkyl.

8. The cationic oligomer of a saccharide according to claim 7, wherein X is nitrogen.

9. The cationic oligomer of a saccharide according to claim 7, wherein X is phosphorus.

10. A cationic oligomer of a saccharide of the general formula (II) 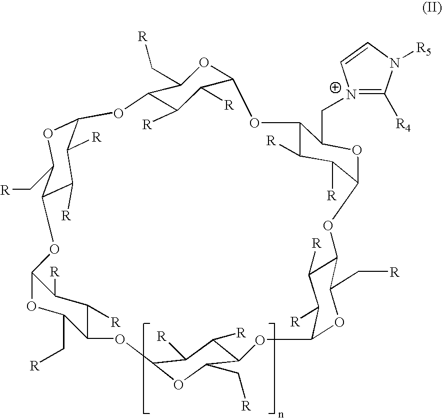
wherein
n=0 to 8;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched chain (C₁-C₂₀)alkyl, hydroxy(C₁-C₂₀)alkyl, carboxy(C₁-C₂₀)alkyl, aryl, or aryl(C₁-C₂₀) alkyl;
R₄ is hydrogen, linear or branched (C₁-C₂₀)alkyl, linear or branched (C₁-C₂₀)alkenyl, linear or branched (C₁-C₂₀)alkynyl, or cycloalkyl; and
R₅ is hydrogen, 2-(2-ethoxyethoxy)ethyl, linear or branched (C₁-C₂₀)alkyl, linear or branched (C₁-C₂₀)alkenyl, linear or branched (C₁-C₂₀)alkynyl, or cycloalkyl.

11. The cationic oligomer of a saccharide according to claim 10, wherein R₄ is hydrogen or methyl.

12. A cationic oligomer of a saccharide of the general formula (III) 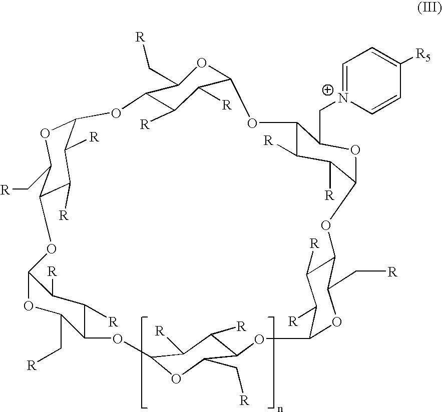
wherein
n=0 to 8;
R is a hydroxyl, an ester, a carbamate, a carbonate, a phosphinate, a phosphonate, a phosphate, a sulfinate, a sulfite, a sulfonate, a sulphate, or R′O—, wherein R′ is linear or branched (C₁-C₂0)alkyl, hydroxy(C₁-C₂₀)alkyl, carboxy(C₁-C₂₀)alkyl, aryl, or aryl(C₁-C₂₀)alkyl; and
R₅ is hydrogen, linear or branched (C₁-C₂₀)alkyl, linear or branched (C₁-C₂₀)alkenyl, linear or branched (C₁-C₂₀)alkynyl, cycloalkyl, or NR₆R₇, wherein R₆ and R₇ are each independently selected from the group consisting of hydrogen, linear or branched (C₁-C₂₀) alkyl, linear or branched (C₁-C₂₀)alkenyl, linear or branched (C₁-C₂₀)alkynyl, and cycloalkyl.

13. The cationic oligomer of a saccharide of claim 1, wherein n is 1, 2, or 3.

14. The cationic oligomer of a saccharide of claim 1, further comprising a counterion.

15. The cationic oligomer of a saccharide to of claim 14, wherein the counterion is fluoride, chloride, bromide, iodide, nitrate, HCO₃⁻, CO₃²⁻, HSO₄⁻, BF₄⁻, BCl₄⁻, PF₆⁻, SbF₆⁻, AsF₆⁻, AlCl₄⁻, R₉-CO₂⁻or R₉—SO₃⁻, wherein R₉ is (C₁-C₂₀)alkyl, linear or branched (C₁-C₂₀)alkenyl, linear or branched (C₁-C₂₀)alkynyl, cycloalkyl, or aryl(C₁-C₂₀)alkyl.

16. A method of preparing a cationic oligomer of a saccharide as defined claim 1 comprising reacting an amine, a phosphine, an imidazole, or a pyridine with an oligomer of the saccharide having a leaving group.

17. The method of claim 16, wherein the leaving group is a halide, a mesylate, a tosylate, a triflate, or a haloformate ester group.

18. The method of claim 17, wherein the halide is an iodide, bromide, or chloride.

19. The method of claim 16, wherein the leaving group is a tosylate.

20. The method of claim 16, wherein the oligomer of a saccharide is mono-6-deoxy-6-tosyl cyclodextrin or mono-2-deoxy-2-tosyl cyclodextrin.

21. The method of claim 16, wherein the amine and phosphine are 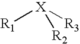
wherein R₁, R₂, and R₃ are defined as in claim 1.

22. The method of claim 21, wherein X is nitrogen.

23. The method of claim 21, wherein X is phosphorous.

24. The method of claim 16, wherein the imidazole is 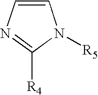
wherein R₄ and R₅ are defined as in claim 1.

25. The method of claim 16, wherein the pyridine is 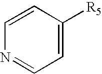
wherein R₅ is defined as in claim 1.

26. A method for enantiomeric separation of a mixture of racemates, comprising:
providing of a cationic oligomer of a saccharide as defined in claim 1 as a chiral agent.
mixing the cationic oligomer of the saccharide with the mixture of racemates; and enantioseparating the racemates by a chromatographic method.

27. The method of claim 26, wherein the chromatographic method is selected from the group consisting of gas chromatography (GC), liquid chromatography (LC), high performance liquid chromatography (HPLC), capillary electrophoresis (CE), and sub or supercritical fluid chromatography (SFC).

28. A method for asymmetric synthesis of a compound, comprising:
providing a cationic oligomer of a saccharide as defined in claim 1 as a chiral agent; and
performing the asymmetric synthesis reaction in the presence of the chiral agent.

29. The method of claim 28, wherein the asymmetric synthesis is a reduction or a pericyclic reaction.

30. The method of claim 29, wherein the pericyclic reaction is an ene or a Diels Alder reaction.

31. The cationic oligomer of a saccharide of claim 10, wherein n is 1, 2, or 3.

32. The cationic oligomer of a saccharide of claim 12, wherein n is 1, 2, or 3.

33. The cationic oligomer of a saccharide of claim 10, further comprising a counterion.

34. The cationic oligomer of a saccharide of claim 12, further comprising a counterion.

35. A method of preparing a cationic oligomer of a saccharide as defined in claim 10, comprising reacting an amine, a phosphine, an imidazole, or a pyridine with an oligomer of the saccharide having a leaving group.

36. A method of preparing a cationic oligomer of a saccharide as defined in claim 12, comprising reacting an amine, a phosphine, an imidazole, or a pyridine with an oligomer of the saccharide having a leaving group.

37. A method for enantiomeric separation of a mixture of racemates, comprising:
providing a cationic oligomer of a saccharide as defined in claim 10 as a chiral agent;
mixing the cationic oligomer of the saccharide with the mixture of racemates; and
enantioseparating the racemates by a chromatographic method.

38. A method for enantiomeric separation of a mixture of racemates, comprising:
providing a cationic oligomer of a saccharide as defined in claim 12 as a chiral agent;
mixing the cationic oligomer of the saccharide with the mixture of racemates; and
enantioseparating the racemates by a chromatographic method.

39. A method for asymmetric synthesis of a compound, comprising:
providing a cationic oligomer of a saccharide as defined in claim 10 as a chiral agent; and
performing the asymmetric synthesis reaction in the presence of the chiral agent.

40. A method for asymmetric synthesis of a compound, comprising:
providing a cationic oligomer of a saccharide as defined in claim 12 as a chiral agent; and
performing the asymmetric synthesis reaction in the presence of the chiral agent.
